(19) United States
(12) Patent Application Publication
(10) Pub. No.: US 2003/0008742 A1
(43) Pub. Date: Jan. 9, 2003

(54) Rotatable shaft and pulley arrangement

(76) Inventor: Leslie A. Kay, Miami, FL (US)

Correspondence Address: Merrill N. Johnson, 800 Harbour Drive, Naples, FL, 34103, US

(21) Appl. No.: 09/895,634

(22) Filed: Jul. 2, 2001

(51) Int. Cl. F16H 55/36

(52) U.S. Cl. 474/182; 474/181

(57) ABSTRACT

A rotatable shaft and pulley arrangement (1) has a tube (2) made of a suitable metal and having ends with knurled outside peripheries (3) onto which pulleys (5, 8) are press fit and laser welded for balanced low-weight attachment. A keyway (9) is stamped into a central portion of the tube to minimize weight imbalance and cost. An attachment wall (10) as preferably a ring groove is rolled into the tube to provide a circumferential attachment base for a fastener head (13) having a fastener shaft (15) that is threaded into an engine shaft for attachment of the tube to the engine shaft.

### FIELD OF THE INVENTION

1. Field of the Invention

This invention relates to pulley shafts to fit onto output shafts of engines for transmitting rotational power to rotary implements that include rotary mower blades.

### BACKGROUND OF THE INVENTION

2. Relation to Prior Art

Engine rotation is transmitted to parallel shafts of rotary mower blades generally with belts and pulleys. Balancing known pulley attachments for this purpose, however, is difficult, expensive and inadequate. Most pulley arrangements for this purpose have relatively high weight which compounds imbalance problems. Imbalance of their heavy weight causes vibration which shortens use life of engines and associated machinery. The vibration also causes operator discomfort which can result in yet greater costs and problems.

### SUMMARY OF THE INVENTION

Objects of patentable novelty and utility taught by this invention are to provide a rotatable shaft and pulley arrangement which:

can be balanced inexpensively;

is light to minimize any imbalance;

avoids user discomfort from vibration; and

enhances use life of engines and equipment on which it is used.

This invention accomplishes these and other objectives with a rotatable shaft and pulley arrangement having a hollow tube made of a suitable steel with knurled ends onto which pulley wheels are press fit and laser welded with balanced low-weight attachment. A keyway is stamped into a central portion of the tube to minimize weight imbalance and cost. A ring groove is rolled into the tube to provide a circumferential attachment base for a bolt that is threaded into an engine shaft for attachment of the tube to the engine shaft.

### BRIEF DESCRIPTION OF DRAWINGS

This invention is described by appended claims in relation to description of a preferred embodiment with reference to the following drawings which are explained briefly as follows:

FIG. 1 is a partially cutaway side view;

FIG. 2 is a first-end view;

FIG. 3 is a second-end view; and

FIG. 4 is an enlarged partially cutaway side view of ends showing laser welds of pulleys to knurled ends.

### DESCRIPTION OF PREFERRED EMBODIMENT

Listed numerically below with reference to the drawings are terms used to describe features of this invention. These terms and numbers assigned to them designate the same features throughout this description.

```
  1. Rotatable shaft and pulley arrangement
  2. Tube
  3. Knurled outside periphery
  4. Hub of first pulley
  5. First pulley
  6. Bead of laser weld
  7. Hub of second pulley
  8. Second pulley
  9. Keyway
10. Attachment wall
11. Washer
12. Fastener-head shoulder
13. Fastener head
14. Circumferential taper
15. Fastener shaft
```

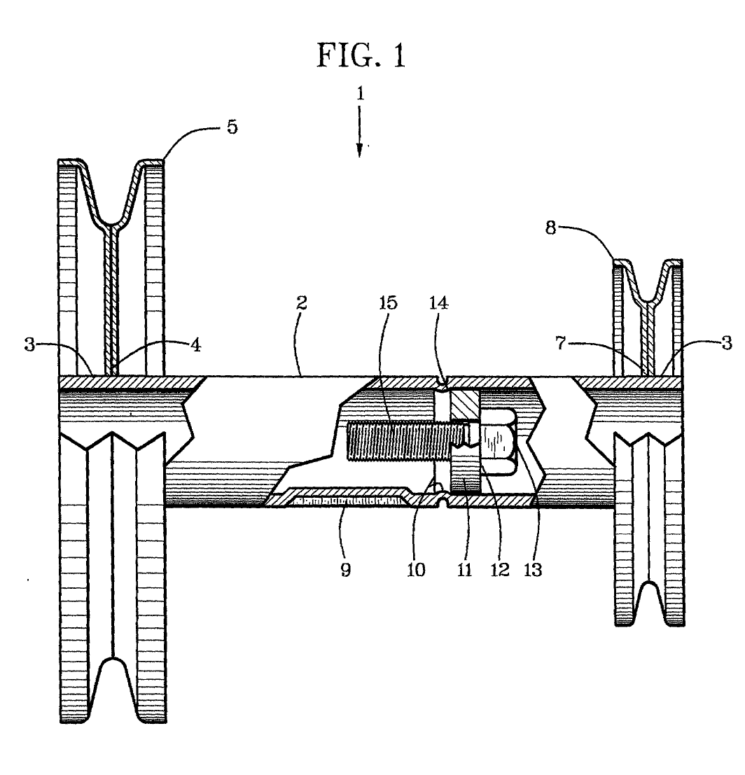

Referring first to FIGS. 1 and 4, a rotatable shaft and pulley arrangement 1 has a tube 2 that is hollow and made preferably of a predetermined metal that includes steel. The tube 2 has a circumferential inside periphery articulated to receive a drive shaft of a predetermined engine, neither of which are shown.

A first end of the tube 2 has a knurled circumferential outside periphery 3 to which an inside periphery of a hub 4 of a first pulley 5 is laser welded with a bead of laser weld 6 with predetermined fineness for minimizing weight and mass imbalance of the rotatable shaft and pulley arrangement 1.

Correspondingly, a second end of the tube 2 has the knurled circumferential outside periphery 3 to which an inside periphery of a hub 7 of a second pulley 8 is laser welded with the bead of laser weld 6 with the predetermined fineness for minimizing the weight and mass imbalance of the rotatable shaft and pulley arrangement 1.

In addition to being laser welded to the knurled outside periphery 3, the hub 4 of the first pulley 5 and the hub 7 of the second pulley 8 are preferably balanced with predeterminedly uniform mass circumferentially and also press fit onto the knurled outside periphery 3 for assurance of rotational balance inexpensively. The knurled outside periphery 3 is preferably crosshatched knurling.

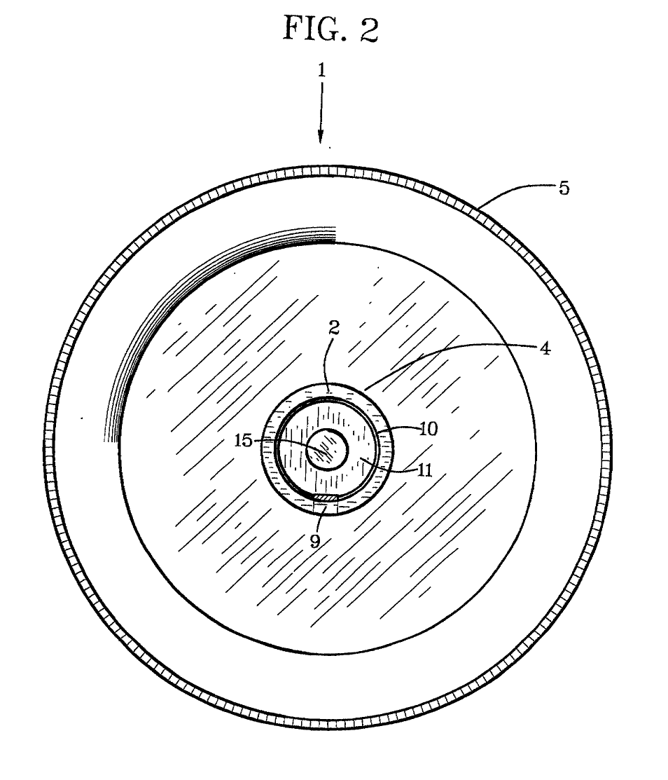

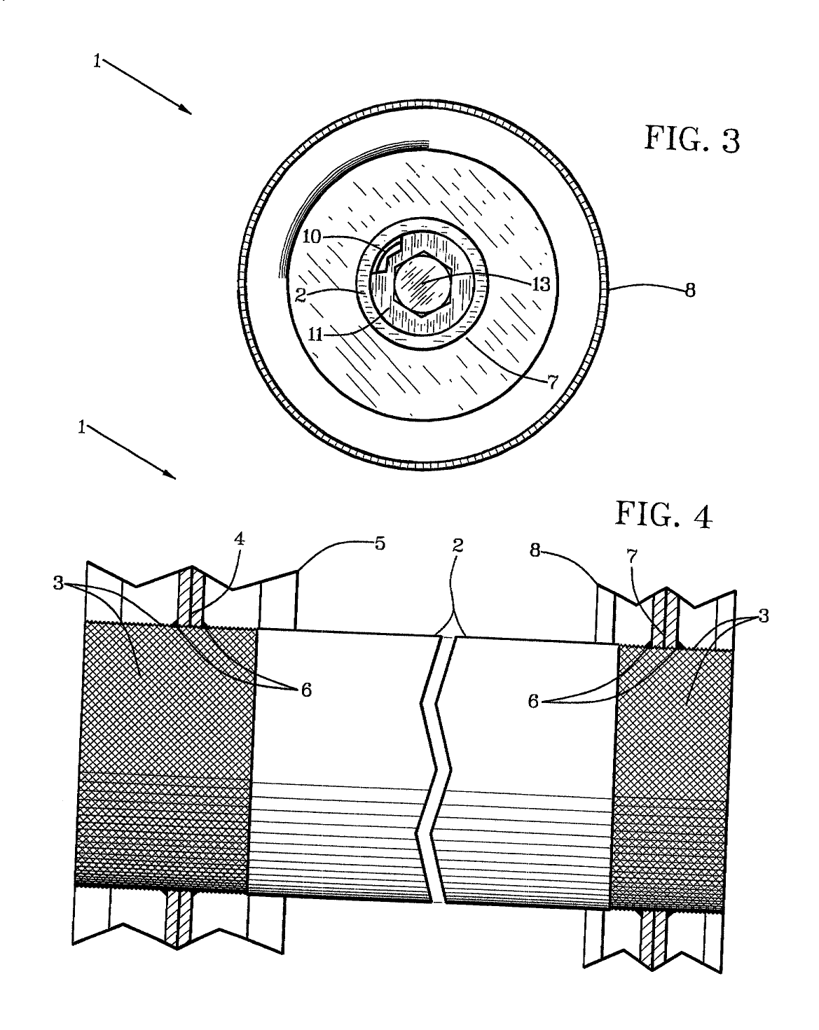

Referring to FIGS. 1-3, a keyway 9 in the outside periphery of the tube 2 is oriented linearly to an axis of the tube 2 intermediate the first pulley 5 and the second pulley 8. The keyway 9 is preferably machine-pressure-stamped in order to minimize mass imbalance and cost factors in a manufacturing process for making keyways.

An attachment wall 10 is extended circumferentially inward from the circumferential inside periphery of the tube 2 at a position predeterminedly intermediate the first end and the second end of the tube 2. The attachment wall 10 is structured, positioned and otherwise articulated to buttress a circumferential fastener member that can include a washer 11 intermediate a fastener-head shoulder 12 of a fastener head 13 and the attachment wall 10.

The attachment wall 10 is preferably a machine-pressure-rolled wall with pressure rolling applied inward radially into the outside periphery of the tube 2 in order to minimize circumferential weight distortion at minimal production cost. Machine-pressure rolling has an additional advantage of providing a circumferential taper 14 articulated to center a circumferential fastener member with tension on a fastener shaft 15 in a direction of the drive shaft that is not shown. Optionally, the attachment wall 10 can be machined internally onto the inside periphery of the tube 2 and provided with the circumferential taper 14.

Laser welding is used due to its low distortion levels. Laser concentrates a high beam of light energy in a very small concentrated area (heat effect zone). Since the area is so small, the part absorbs much less heat than conventional welding methods. Therefore, distortion, heat effect zone and assembly run-out are kept to a minimum.

A new and useful rotatable shaft and pulley arrangement having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A rotatable shaft and pulley arrangement comprising:
a hollow rotatable steel tube;
a knurl attached to one end of the tube;
a second knurl attached to the opposite end of the tube;
the axes of the knurls being the axis of the rotatable tube and the outer surface of each knurl being cross-hatched;
a keyway stamped into the tube near the middle of the tube;
a ring rolled into the tube and positioned against the keyway to enable the tube to be affixed to an engine drive shaft;
a bolt whose head lies against the ring and is held in place by a washer on the bolt's threaded end;
an endless belt driven pulley affixed to one end of the hollow tube;
a second endless belt driven pulley affixed to the other end of the hollow tube; and
both pulleys being attached to the hollow tube by laser welding.

2. A rotatable shaft and pulley arrangement comprising:
a tube made of a predetermined metal;
the tube having a circumferential inside periphery articulated to receive a drive shaft of a predetermined engine;
the tube having a first end with a knurled circumferential outside periphery to which an inside periphery of a hub of a first pulley is laser welded;
the tube having a second end with a knurled circumferential outside periphery to which an inside periphery of a hub of a second pulley is laser welded;
a keyway in the outside periphery of the tube;
the keyway being oriented linearly to an axis of the tube a desired distance predeterminedly intermediate the first pulley and the second pulley;
an attachment wall extended circumferentially inward from the circumferential inside periphery of the tube predeterminedly intermediate the first end and the second end of the tube; and
the attachment wall being articulated to buttress a circumferential fastener member with which the tube is attachable to the drive shaft of the predetermined engine.

3. The rotatable shaft and pulley arrangement of claim 2 wherein:
the tube is balanced with predeterminedly uniform mass circumferentially.

4. The rotatable shaft and pulley arrangement of claim 2 wherein:
the first pulley and the second pulley are balanced with predeterminedly uniform mass circumferentially.

5. The rotatable shaft and pulley arrangement of claim 2 wherein:
knurl of the first end and knurl of the second end of the tube are crosshatched.

6. The rotatable shaft and pulley arrangement of claim 2 wherein:
the inside periphery of the hub of the first pulley is press-fit onto the outside periphery of the knurl of the first end of the tube; and
the inside periphery of the hub of the second pulley is press-fit onto the outside periphery of the knurl of the second end of the tube.

7. The rotatable shaft and pulley arrangement of claim 2 wherein:
the keyway in the outside periphery of the tube is a machine-pressure-stamped keyway.

8. The rotatable shaft and pulley arrangement of claim 2 wherein:
the attachment wall is a machine-pressure-rolled wall with pressure rolling applied inward radially onto the outside periphery of the tube.

9. The rotatable shaft and pulley arrangement of claim 2 wherein:
the rotatable shaft and pulley arrangement is balanced with predeterminedly uniform mass circumferentially.

10. The rotatable shaft and pulley arrangement of claim 2 wherein:
beads of weld metal with which the hub of the first pulley and the hub of the second pulley are laser welded to the tube have predetermined fineness for minimizing weight and mass imbalance of the rotatable shaft and pulley arrangement circumferentially.

11. The rotatable shaft and pulley arrangement of claim 2 wherein:
the circumferential fastener member with which the tube is attachable to the drive shaft includes a washer intermediate a fastener-head shoulder and the attachment wall; and
a fastener shaft on the fastener head is extended axially through an orifice in the washer and an orifice in the attachment wall in a direction of the drive shaft for being screwed into the drive shaft.

12. The rotatable shaft and pulley arrangement of claim 2 wherein:
the attachment wall includes a circumferential taper articulated to center a circumferential fastener member with tension on the fastener shaft in a direction of the drive shaft.

13. A rotatable shaft and pulley arrangement comprising:
a tube made of a predetermined metal;
the tube being balanced with predeterminedly uniform mass circumferentially;
the tube having a circumferential insider periphery articulated to receive a drive shaft of a predetermined engine;
the tube having a first end with a knurled circumferential outside periphery to which an inside periphery of a hub of a first pulley is laser welded;
the tube having a second end with a knurled circumferential outside periphery to which an inside periphery of a hub of a second pulley is laser welded;
the first pulley and the second pulley being balanced with predeterminedly uniform mass circumferentially;
a keyway in the outside periphery of the tube;
the keyway being oriented linearly to an axis of the tube a desired distance predeterminedly intermediate the first pulley and the second pulley;
the keyway in the outside periphery of the tube being a machine-pressure-stamped keyway;
an attachment wall extended circumferentially inward from the circumferential inside periphery of the tube predeterminedly intermediate the first end and the second end of the tube; and
the attachment wall being articulated to buttress a circumferential fastener member with which the tube is attachable to the drive shaft of the predetermined engine.

14. The rotatable shaft and pulley arrangement of claim 13 wherein:
the rotatable shaft and pulley arrangement is balanced with predeterminedly uniform mass circumferentially.

15. The rotatable shaft and pulley arrangement of claim 13 wherein:
beads of weld metal with which the hub of the first pulley and the hub of the second pulley are laser welded to the tube have predetermined fineness for minimizing weight and mass imbalance of the rotatable shaft and pulley arrangement circumferentially.

16. The rotatable shaft and pulley arrangement of claim 13 wherein:
the circumferential fastener member with which the tube is attachable to the drive shaft includes a washer intermediate a fastener-head shoulder and the attachment wall; and
a fastener shaft on the fastener head is extended axially through an orifice in the washer and an orifice in the attachment wall in a direction of the drive shaft for being screwed into the drive shaft.

17. The rotatable shaft and pulley arrangement of claim 16 wherein:
the attachment wall includes a circumferential taper articulated to center a circumferential fastener member with tension on the fastener shaft in a direction of the drive shaft.

18. The rotatable shaft and pulley arrangement of claim 17 wherein:
the attachment wall includes a circumferential taper articulated to center a circumferential fastener member with tension on the fastener shaft in a direction of the drive shaft.

19. The rotatable shaft and pulley arrangement of claim 13 wherein:
the knurled outside periphery is crosshatched knurling.
